(19) United States
(12) Patent Application Publication
(10) Pub. No.: US 2021/0204785 A1
(43) Pub. Date: Jul. 8, 2021

(54) ARTIFICIAL INTELLIGENCE MOVING AGENT

(71) Applicant: LG ELECTRONICS INC., Seoul (KR)

(72) Inventors: Kamin LEE, Seoul (KR); Suyeon KIM, Seoul (KR); Seungah CHAE, Seoul (KR)

(73) Assignee: LG ELECTRONICS INC., Seoul (KR)

(21) Appl. No.: 16/499,715

(22) PCT Filed: Jul. 31, 2019
(86) PCT No.: PCT/KR2019/009527

§ 371 Date: Sep. 30, 2019

(51) Int. Cl. A47L 11/40; G05D 1/00; G05D 1/02; G06T 7/246; H04N 7/18; G06N 3/08

(52) U.S. Cl. CPC A47L 11/4011; G05D 1/0088; G05D 1/0246; G06T 7/248; G06T 2207/20084; G06N 3/08; A47L 2201/04; G05D 2201/0203; G06T 2207/20081; H04N 7/185

(57) ABSTRACT

Disclosed is an artificial intelligence moving agent. The artificial intelligence moving agent includes a communicator in communication with a terminal of a user, a camera for shooting an image, and a processor for detecting a movement of an object, providing an image of the object to an artificial intelligence model to obtain information on whether to transmit the image of the object when the movement of the object is detected, and transmitting the image of the object to the terminal based on the obtained information.

### TECHNICAL FIELD

The present disclosure relates to an artificial intelligence moving agent that may select and transmit only an image a user desires to receive.

### BACKGROUND ART

Artificial intelligence is a field of computer engineering and information technology that studies a method for allowing computers to think, learn, self-develop, and the like that may be performed by human intelligence. The artificial intelligence means that the computers may imitate the human intelligence.

Further, the artificial intelligence does not exist by itself, but directly or indirectly related to other fields of the computer science. Particularly in the modern age, attempts to introduce artificial intelligence elements in various fields of the information technology and to utilize the artificial intelligence elements in solving problems in the field are being actively carried out.

In one example, a technology of recognizing and learning a surrounding situation using artificial intelligence and providing information desired by a user in a desired form or performing an operation or function desired by the user has been actively researched.

Further, an electronic device that provides such various operations and functions may be referred to as an artificial intelligence device.

Recently, a robot cleaner that serves as a CCTV inside a house through a mounted camera is commercially available. Further, the robot cleaner transmits an image to a terminal of a user when a movement of an object is detected. However, the transmitted images may include a plurality of images that the user does not desire to receive.

### DISCLOSURE

### Technical Purpose

The present disclosure is to solve the above-mentioned problems. A purpose of the present disclosure is to provide an artificial intelligence moving agent that may select and transmit only images a user desires to receive.

### Technical Solution

In an aspect, an artificial intelligence moving agent is provided. The artificial intelligence moving agent includes a communicator in communication with a terminal of a user, a camera for shooting an image, and a processor for detecting a movement of an object, providing an image of the object to an artificial intelligence model to obtain information on whether to transmit the image of the object when the movement of the object is detected, and transmitting the image of the object to the terminal based on the obtained information.

### Technical Effect

According to the present disclosure, the robot cleaner first determines whether the shooted image is the image desired by the user and then selects the image and transmits the selected image to the terminal. Thus, transmission of the undesired images may be prevented.

### BRIEF DESCRIPTION OF THE DRAWINGS

FIG. 1 illustrates an AI device 100 according to an embodiment of the present disclosure.

FIG. 2 illustrates an AI server 200 according to an embodiment of the present disclosure.

FIG. 3 illustrates an AI system 1 according to an embodiment of the present disclosure.

FIG. 4A is a perspective view of a robot cleaner according to an embodiment of the present disclosure.

FIG. 4B illustrates a horizontal angle of view of the robot cleaner of FIG. 4A.

FIG. 4C is a front view of the robot cleaner of FIG. 4A.

FIG. 4D illustrates the bottom of the robot cleaner of FIG. 4A.

FIG. 4E is a block diagram illustrating the main parts of the robot cleaner according to an embodiment of the present disclosure.

FIG. 5 is a view for illustrating a method for operating a moving agent 100 according to an embodiment of the present disclosure.

FIG. 6 is a diagram for illustrating a method for detecting a movement of an object and obtaining an image.

FIG. 7 is a diagram for illustrating a method for operating a moving agent using an artificial intelligence model.

FIG. 8 is a diagram for illustrating a method for transmitting feedback of a terminal according to an embodiment of the present disclosure.

FIG. 9 illustrates a method for training an artificial intelligence model according to an embodiment of the present disclosure.

FIG. 10 is a diagram for illustrating a method for receiving an input for setting whether to transmit an image from a terminal according to an embodiment of the present disclosure.

FIG. 11 is a diagram for illustrating a method for tracking an object desired by a user according to an embodiment of the present disclosure.

### DETAILED DESCRIPTIONS

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the disclosure in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep running is part of machine running. In the following, machine learning is used to mean deep running.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

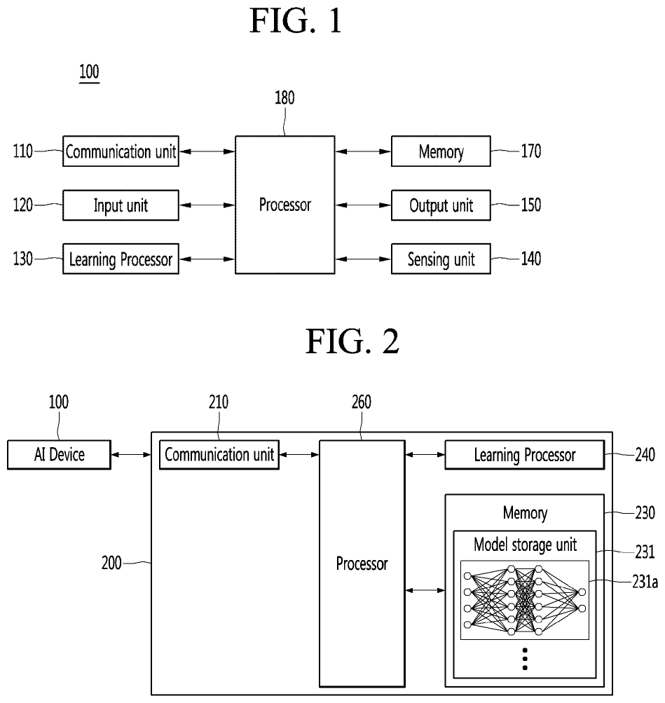

FIG. 1 illustrates an AI device 100 according to an embodiment of the present disclosure.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI device 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using, the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

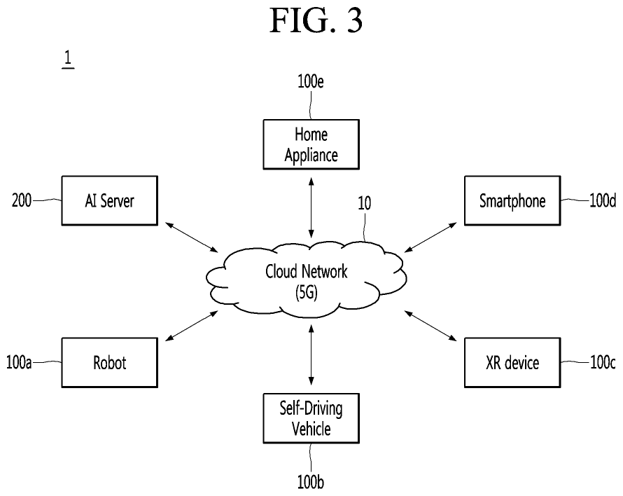

FIG. 3 illustrates an AI system 1 according to an embodiment of the present disclosure.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+ Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. At this time, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

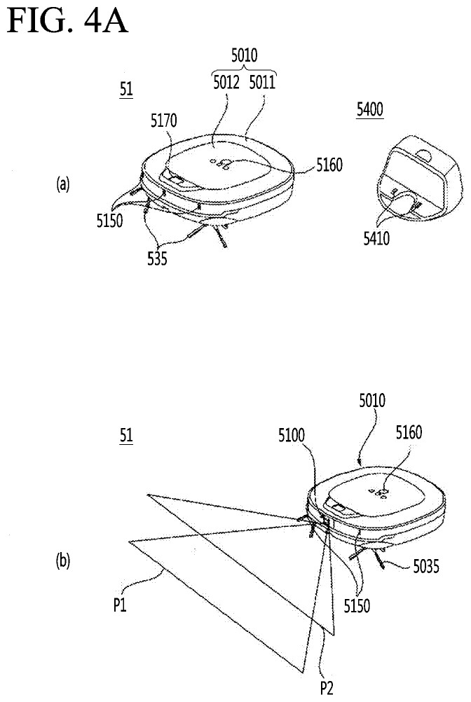

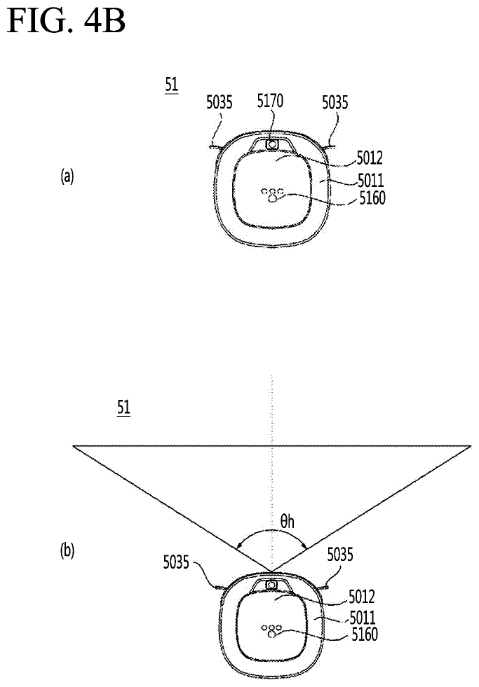

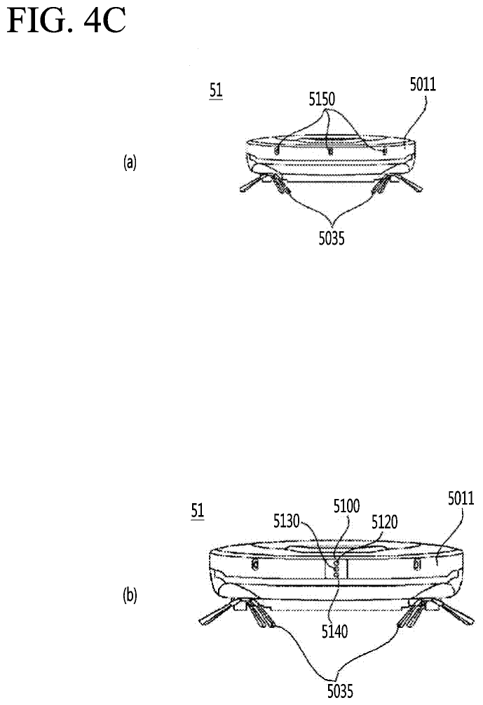

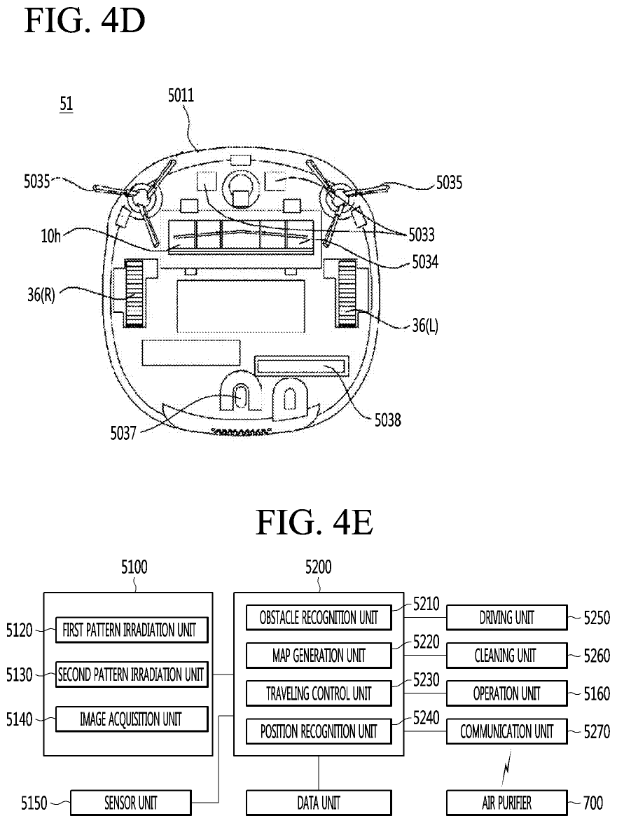

FIG. 4A is a perspective view of a robot cleaner according to an embodiment of the present disclosure. FIG. 4B illustrates a horizontal angle of view of the robot cleaner of FIG. 4A. FIG. 4C is a front view of the robot cleaner of FIG. 4A. FIG. 4D illustrates the bottom of the robot cleaner of FIG. 4A.

Referring to FIGS. 4A to 4D, a robot cleaner 51 according to an embodiment of the present disclosure a main body 5010 that moves along a floor of a cleaning area and suctions foreign substances such as dust on the floor, and an obstacle detection unit 5100 disposed in front of the main body 5010.

The main body 5010 may include a casing 5011 forming an appearance and defining a space in which components constituting the main body 5010 are accommodated, a suction unit 5034 disposed in the casing 5011 to suction foreign substances such as dust or garbage, and a left wheel 36(L) and a right wheel 36(R) rotatably provided in the casing 5011. As the left wheel 36(L) and the right wheel 36(R) rotate, the main body 5010 moves along the floor of the cleaning area. In this process, foreign substances are suctioned through the suction unit 5034.

The suction unit 5034 may include a suction fan (not shown) for generating a suction force and a suction port 10h through which air flow generated by the rotation of the suction fan is suctioned. The suction unit 5034 may include a filter (not shown) for collecting foreign substances from the air flow suctioned through the suction port 10h, and a foreign substance collection container (not shown) in which foreign substances collected by the filter are accumulated.

In addition, the main body 5010 may include a driving unit for driving the left wheel 36(L) and the right wheel 36(R). The driving unit may include at least one driving motor. The at least one driving motor may include a left wheel driving motor for rotating the left wheel 36(L) and a right wheel driving motor for rotating the right wheel 36(R).

The left wheel driving motor and the right wheel driving motor may be independently controlled by a traveling control unit of a control unit to achieve forward movement, backward movement, or rotation. For example, if the main body 5010 travels straight, the left wheel driving motor and the right wheel driving motor rotate in the same direction. However, if the left wheel driving motor and the right wheel driving motor rotate at different speeds or rotate in opposite directions, the traveling direction of the main body 5010 may be switched. At least one auxiliary wheel 5037 may be further provided for stably supporting the main body 5010.

A plurality of brushes 5035 disposed on the front side of the bottom of the casing 5011 and having a brush with a plurality of radially extending wins may be further provided. Dusts are removed from the floor of the cleaning area by the rotation of the plurality of brushes 5035. The dusts separated from the floor are suctioned through the suction port 10h and collected in the collection container.

A control panel including an operation unit 5160 for receiving various commands for controlling the robot cleaner 51 from the user may be provided on the upper surface of the casing 5011.

The obstacle detection unit 5100 may be disposed in front of the main body 5010.

The obstacle detection unit 5100 is fixed to the front surface of the casing 5011 and includes a first pattern irradiation unit 5120, a second pattern irradiation unit 5130, and an image acquisition unit 5140. In this case, the image acquisition unit 5140 is basically installed below the pattern irradiation unit as shown, but in some cases, may be disposed between the first and second pattern irradiation unit. In addition, a second image acquisition unit (not shown) may be further provided at the upper end of the main body. The second image acquisition unit captures an image of the upper end of the main body, that is, the ceiling.

The main body 5010 is provided with a rechargeable battery 5038. A charging terminal 5033 of the battery 5038 is connected to a commercial power source (for example, a power outlet in a home), or the main body 5010 is docked on a separate charging station (not shown) connected to the commercial power source. In this manner, the charging terminal 5033 is electrically connected to the commercial power source, thereby achieving the charging of the battery 5038. Electrical components constituting the robot cleaner 51 may receive power from the battery 5038. Therefore, if the battery 5038 is in a charged state, the robot cleaner 51 may be traveled by itself in a state in which the battery 5038 is electrically separated from the commercial power source.

FIG. 4E is a block diagram illustrating the main parts of the robot cleaner according to an embodiment of the present disclosure.

As shown in FIG. 4E, the robot cleaner 51 may include a control unit 5200 for controlling a driving unit 5250, a cleaning unit 5260, a data unit 5280, an obstacle detection unit 5100, a sensor unit 5150, a communication unit 5270, an operation unit 5160, and an overall operation. The control unit may be implemented by one or more microprocessors, and may be implemented by a hardware device.

The operation unit 5160 may include an input unit such as at least one button, a switch, or a touch pad, and may receive a user command. As described above, the operation unit may be provided at the upper end of the main body 5010.

The data unit 5280 stores an obstacle detection signal input from the obstacle detection unit 5100 or the sensor unit 5150, stores reference data for allowing the obstacle recognition unit 5210 to determine the obstacle, and stores obstacle information about the detected obstacle. In addition, the data unit 5280 stores control data for controlling the operation of the robot cleaner and data according to the cleaning mode of the robot cleaner, and stores a map including obstacle information generated by a map generation unit. The data unit 5280 may store a base map, a cleaning map, a user map, and a guide map. The obstacle detection signal includes a detection signal such as an ultrasonic wave/laser by the sensor unit and an acquired image of the image acquisition unit.

In addition, the data unit 5280 stores data that can be read by a microprocessor. The data unit 5280 may include hard disk drive (HDD), solid state disk (SSD), silicon disk drive (SDD), ROM, RAM, CD-ROM, magnetic tape, floppy disk, and optical data storage devices.

The communication unit 5270 communicates with the air cleaner in a wireless communication manner. In addition, the communication unit 5270 may be connected to an Internet network through a home network to communicate with an external server or an air cleaner.

The communication unit 5270 transmits the generated map to the air cleaner, and transmits data related to the operation state of the robot cleaner and the cleaning state to the air cleaner. The communication unit 5270 includes a communication module such as Wi-Fi or WiBro, as well as short-range wireless communication such as Zigbee or Bluetooth, and transmits and receives data.

The driving unit 5250 includes at least one driving motor to allow the robot cleaner to travel according to the control command of the traveling control unit 5230. As described above, the driving unit 5250 may include the left wheel driving motor for rotating the left wheel 36(L) and the right wheel driving motor for rotating the right wheel 36(R).

The cleaning unit 5260 operates the brush to make a state in which dusts or foreign substances around the robot cleaner can be easily suctioned, and operates the suction device to suction dusts or foreign substances. The cleaning unit 5260 controls the operation of the suction fan provided in the suction unit 34 for suctioning the foreign substances such as dusts or garbage, so that the dusts are introduced into the foreign substance collection container through the suction port.

The obstacle detection unit 5100 includes a first pattern irradiation unit 5120, a second pattern irradiation unit 5130, and an image acquisition unit 5140.

The sensor unit 5150 includes a plurality of sensors to assist in detecting a failure. The sensor unit 5150 may include at least one of a laser sensor, an ultrasonic sensor, or an infrared sensor. The sensor unit 5150 detects an obstacle in front of the main body 5010, that is, a driving direction, by using at least one of laser, ultrasonic waves, or infrared rays. If the transmitted signal is reflected and incident on the sensor unit 5150, the sensor unit 5150 inputs information about the presence or absence of the obstacle or a distance to the obstacle to the control unit 5200 as an obstacle detection signal.

In addition, the sensor unit 5150 includes at least one tilt sensor to detect the tilt of the main body. The tilt sensor calculates the tilted direction and angle if the main body is tilted in the front, rear, left and right directions. The tilt sensor may be a tilt sensor, an acceleration sensor, or the like. In the case of the acceleration sensor, any one of a gyro type, an inertial type, and a silicon semiconductor type may be applied.

Meanwhile, the sensor unit 5150 may include at least one of the components of the obstacle detection unit 5100 and may perform the function of the obstacle detection unit 5100.

In the obstacle detection unit 5100, the first pattern irradiation unit 5120, the second pattern irradiation unit 5130, and the image acquisition unit 5140 are installed in front of the main body 5010 as described above, so that lights P1 and P2 of the first and second patterns are irradiated to the front of the robot cleaner and the lights of the irradiated patterns are captured to obtain the image.

In addition, the sensor unit 5150 may include a dust sensor for detecting the amount of dusts in the air and a gas sensor for detecting the amount of gas in the air.

The obstacle detection unit 5100 inputs the acquired image to the control unit 5200 as an obstacle detection signal.

The first and second pattern irradiation units 5120 and 5130 of the obstacle detection unit 5100 may include a light source and an optical pattern projection element (OPPE) that generates a predetermined pattern by transmitting light emitted from the light source. The light source may be a laser diode (LD), a light emitting diode (LED), or the like. Since laser light is superior to other light sources in terms of monochromaticity, straightness, and connection properties, the distance can be accurately measured. In particular, since infrared or visible light has a problem that a large deviation occurs in the accuracy of distance measurement, depending on factors such as color and material of an object, the laser diode is preferable as the light source. The OPPE may include a lens and a diffractive optical element (DOE). Light of various patterns may be irradiated according to the configuration of the OPPE provided in each of the pattern irradiation units 5120 and 5130.

The first pattern irradiation unit 5120 may irradiate the light P1 of the first pattern (hereinafter, referred to as first pattern light) toward the front lower side of the main body 5010. Therefore, the first pattern light P1 may be incident on the floor of the cleaning area.

The first pattern light P1 may be configured in the form of a horizontal line Ph. In addition, the first pattern light P1 may be configured in the form of a cross pattern in which a horizontal line Ph and a vertical line Pv intersect with each other.

The first pattern irradiation unit 5120, the second pattern irradiation unit 5130, and the image acquisition unit 5140 may be vertically arranged in a line. The image acquisition unit 5140 is disposed below the first pattern irradiation unit 5120 and the second pattern irradiation unit 5130, but the present disclosure is not limited thereto. The image acquisition unit 5140 may be disposed above the first pattern irradiation unit and the second pattern irradiation unit.

In an embodiment, the first pattern irradiation unit 5120 may be disposed at the upper side and may irradiate the first pattern light P1 downwardly toward the front to detect the obstacle disposed below the first pattern irradiation unit 5120. The second pattern irradiation unit 5130 may be disposed below the first pattern irradiation unit 5120 and may irradiate the light P2 of the second pattern (hereinafter, referred to as second pattern light) upwardly toward the front. Therefore, the second pattern light P2 may be incident on the obstacle or a portion of the obstacle that is disposed at least higher than the second pattern irradiation unit 5130 from the wall or the floor of the cleaning area.

The second pattern light P2 may be formed in a pattern different from that of the first pattern light P1, and preferably includes a horizontal line. The horizontal line is not necessarily a continuous line segment, and may be a dashed line.

Meanwhile, in FIG. 2 described above, the illustrated irradiation angle θh indicates the horizontal irradiation angle of the first pattern light P1 irradiated from the first pattern irradiation unit 5120. Both ends of the horizontal line Ph indicate an angle formed with the first pattern irradiation unit 5120, and are preferably defined in the range of 130° to 140°, but are not necessarily limited thereto. The dashed line shown in FIG. 2 is directed toward the front of the robot cleaner 51, and the first pattern light P1 may be configured to be symmetrical with respect to the dashed line.

Similar to the first pattern irradiation unit 5120, the second pattern irradiation unit 5130 may also have a horizontal irradiation angle, preferably, in the range of 130° to 140°. According to an embodiment, the second pattern light P2 may be irradiated at the same horizontal irradiation angle as that of the first pattern irradiation unit 5120. In this case, the second pattern light P2 may also be configured to be symmetrical with respect to the dashed line shown in FIG. 2.

The image acquisition unit 5140 may acquire an image in front of the main body 5010. In particular, the pattern lights P1 and P2 appear in an image acquired by the image acquisition unit 5140 (hereinafter, referred to as an acquired image). Hereinafter, the images of the pattern lights P1 and P2 shown in the acquired image is referred to as a light pattern. Since the pattern lights P1 and P2 substantially incident on the real space are images formed on the image sensor, the same reference numerals as the pattern lights P1 and P2 are assigned. The images respectively corresponding to the first pattern light P1 and the second pattern light P2 are referred to as the first light pattern P1 and the second light pattern P2.

The image acquisition unit 5140 may include a digital camera that converts an image of an object into an electrical signal, converts the electrical signal into a digital signal, and stores the digital signal in a memory device. The digital camera may include an image sensor (not shown) and an image processor (not shown).

The image sensor is a device that converts an optical image into an electrical signal, and includes a chip in which a plurality of photodiodes are integrated. Examples of the photodiode may include a pixel. Charges are accumulated in each pixel by the image formed on the chip by light passing through the lens, and the charges accumulated in the pixel are converted into an electrical signal (e.g., voltage). As the image sensor, a charge coupled device (CCD), a complementary metal oxide semiconductor (CMOS), and the like are well known.

The image processor generates a digital image based on the analog signal output from the image sensor. The image processor may include an AD converter for converting an analog signal into a digital signal, a buffer memory for temporarily recording digital data according to the digital signal output from the AD converter, and a digital signal processor (DSP) for processing information recorded in the buffer memory to form a digital image.

The control unit 5200 includes an obstacle recognition unit 5210, a map generation unit 5220, a traveling control unit 5230, and a position recognition unit 5240.

The obstacle recognition unit 5210 determines an obstacle based on an acquired image input from the obstacle detection unit 5100, and the traveling control unit 5230 controls the driving unit 5250 to pass through the obstacle or avoid the obstacle by changing the moving direction or the traveling route in response to the obstacle information.

The traveling control unit 5230 controls the driving unit 5250 to independently control the operations of the left wheel driving motor and the right wheel driving motor, so that the main body 5010 travels straight or rotates.

The obstacle recognition unit 5210 stores the obstacle detection signal input from the sensor unit 5150 or the obstacle detection unit 5100 in the data unit 5280, and analyzes the obstacle detection signal to determine the obstacle.

The obstacle recognition unit 5210 determines the presence or absence of the obstacle in front based on the signal of the sensor unit, and analyzes the acquired image to determine the position, the size, and the shape of the obstacle.

The obstacle recognition unit 5210 analyzes the acquired image to extract a pattern. The obstacle recognition unit 5210 extracts a light pattern that appears if the pattern light emitted from the first pattern irradiation unit or the second pattern irradiation unit is irradiated on the floor or the obstacle, and determines the obstacle based on the extracted light pattern.

The obstacle recognition unit 5210 detects the light patterns P1 and P2 from the image acquired by the image acquisition unit 5140 (acquired image). The obstacle recognition unit 5210 may detect features of points, lines, planes, and the like with respect to predetermined pixels constituting the acquired image, and may detect the light patterns P1 and P2 or the points, lines, planes, and the like constituting the light patterns P1 and P2, based on the detected features

The obstacle recognition unit 5210 may extract line segments formed by successive pixels brighter than the surroundings, and extract the horizontal line Ph constituting the first light pattern P1 and the horizontal line constituting the second light pattern P2. However, the present disclosure is not limited thereto. Various techniques for extracting a desired pattern from a digital image are known. The obstacle recognition unit 5210 may extract the first light pattern P1 and the second light pattern P2 by using these known techniques.

In addition, the obstacle recognition unit 5210 determines the presence or absence of the obstacle based on the detected pattern, and determines the shape of the obstacle. The obstacle recognition unit 5210 may determine the obstacle through the first light pattern and the second light pattern, and calculate a distance to the obstacle. In addition, the obstacle recognition unit 5210 may determine the size (height) and the shape of the obstacle by changing the shapes of the first light pattern and the second light pattern and the light pattern appearing while the obstacle approaches.

The obstacle recognition unit 5210 determines the obstacle with respect to the first light pattern and the second light pattern based on the distance from the reference position. If the first light pattern P1 appears at a position lower than the reference position, the obstacle recognition unit 5210 may determine that a downhill slope exists, and if the first light pattern P1 disappears, the obstacle recognition unit 5210 may determine that a cliff exists. In addition, if the second light pattern appears, the obstacle recognition unit 5210 may determine the obstacle in front or the obstacle in the upper portion.

The obstacle recognition unit 5210 determines whether the main body is tilted based on tilt information input from the tilt sensor of the sensor unit 5150. If the main body is tilted, the tilt with respect to the position of the light pattern of the acquired image is compensated.

The traveling control unit 5230 controls the driving unit 5250 to perform the cleaning while traveling through the designated area of the cleaning area and controls the cleaning unit 5260 to perform the cleaning by suctioning the dusts during the traveling.

In response to the obstacle recognized by the obstacle recognition unit 5210, the traveling control unit 5230 controls the driving unit 5250 by setting the traveling route so as to determine whether the robot cleaner is capable of traveling or entering, approach the obstacle to travel, or pass through the obstacle, or avoid the obstacle.

The map generation unit 5220 generates the map for the cleaning area based on the information about the obstacle determined by the obstacle recognition unit 5210.

During the initial operation or if the map of the cleaning area is not stored, the map generation unit 5220 generates the map for the cleaning area based on the obstacle information while traveling through the cleaning area. In addition, the map generation unit 5220 updates the previously generated map based on the obstacle information acquired during traveling.

The map generation unit 5220 generates a base map based on the information acquired by the obstacle recognition unit 5210 during traveling, and generates a cleaning map by dividing an area from the base map. In addition, the map generation unit 5220 generates a user map and a guide map by arranging the area with respect to the cleaning map and setting the attributes of the area.

The base map is a map in which the shape of the cleaning area acquired through the traveling is displayed as an outline, and the cleaning map is a map in which the areas are divided in the base map. The base map and the cleaning map include information about the area where the robot cleaner can travel and the obstacle information. The user map is a map that has a visual effect by simplifying the area of the cleaning map and arranging the outlines. The guide map is a superimposed map of the cleaning map and the user map. Since the cleaning map is displayed on the guide map, a cleaning command may be input based on an area where the robot cleaner can actually travel.

After generating the base map, the map generation unit 5220 may divide the cleaning area into a plurality of areas, include a connection passage connecting the plurality of areas, and generate a map including information about the obstacle in each area. The map generation unit 5220 divides sub-areas so as to distinguish the areas on the map, sets the representative area, sets the separated sub-areas as separate detailed areas, and merges the same into the representative area to generate a map in which the areas are divided.

The map generation unit 5220 processes the shape of the area for each divided area. The map generation unit 5220 sets the attributes to the divided areas and processes the shape of the area according to the attributes for each area.

The map generation unit 5220 preferentially determines the main area in each of the divided areas based on the number of contacts with other areas. The main area is basically a living room, but in some cases, the main area may be changed to any one of a plurality of rooms. The map generation unit 5220 sets attributes to the remaining areas based on the main area. For example, the map generation unit 5220 may set an area having a predetermined size or more arranged around the living room, which is the main area, as a room, and may set the remaining areas as other areas.

In processing the shape of the area, the map generation unit 5220 processes each area to have a specific shape according to a criterion based on the attribute of the area. For example, the map generation unit 5220 processes the shape of the area based on the shape of a general home room, for example, a rectangle. In addition, the map generation unit 5220 expands the shape of the area based on the outermost cell of the base map, and processes the shape of the area by deleting or reducing the area with respect to the area inaccessible due to the obstacle.

In addition, the map generation unit 5220 may display obstacles equal to or greater than a predetermined size on the map according to the size of the obstacle, and may delete obstacles less than the predetermined size from the corresponding cell so that the obstacle is not displayed. For example, the map generation unit displays furniture such as chairs or sofas equal to or greater than a certain size on the map, and deletes temporarily appearing obstacles, small toys, for example, small toys, etc., from the map. The map generation unit 5220 stores the position of the charging station together on the map if the map is generated.

After the map is generated, the map generation unit 5220 may add an obstacle on the map based on the obstacle information input from the obstacle recognition unit 21 with respect to the detected obstacle. If a specific obstacle is repeatedly detected at a fixed position, the map generation unit 5220 adds an obstacle to the map, and if the obstacle is temporarily detected, the map generation unit 5220 ignores the obstacle.

The map generation unit 5220 generates both the user map that is a processed map and the guide map in which the user map and the cleaning map are overlapped and displayed.

In addition, if a virtual wall is set, the map generation unit 5220 sets the position of the virtual wall on the cleaning map based on data related to the virtual wall received through the communication unit, and calculates the coordinates of the virtual wall corresponding to the cleaning area. The map generation unit 5220 registers the virtual wall in the cleaning map as an obstacle.

The map generation unit 5220 stores data related to the set virtual wall, for example, information about the level of the virtual wall and the attribute of the virtual wall.

The map generation unit 5220 enlarges the set virtual wall and registers the same as an obstacle. During traveling, the main body 5010 is set to a wider range by enlarging the virtual wall set so as not to contact or invade the virtual wall.

If the map generation unit 5220 cannot determine the current position of the main body 5010 by the position recognition unit 5240, the map generation unit 5220 generates a new map for the cleaning area. The map generation unit 5220 may determine that the robot cleaner has moved to the new area and initialize the preset virtual wall.

If data related to the virtual wall is received during traveling, the map generation unit 5220 further sets the virtual wall on the map so as to operate in response to the virtual wall if the main body 5010 travels. For example, if a new virtual wall is added, if the level or attribute of the virtual wall changes, or if the position of the preset virtual wall is changed, the map generation unit 5220 updates the map based on the received data so that the information about the changed virtual wall is reflected to the map.

The position recognition unit 5240 determines the current position of the main body 5010 based on the map (cleaning map, guide map, or user map) stored in the data unit.

If the cleaning command is input, the position recognition unit 5240 determines whether the current position of the main body matches the position on the map. If the current position does not match the position on the map, or if the current position cannot be confirmed, the position recognition unit 5240 recognizes the current position and restores the current position of the robot cleaner 51. If the current position is restored, the traveling control unit 5230 controls the driving unit so as to move to the designated area based on the current position. The cleaning command may be input from a remote controller (not shown), the operation unit 5160, or an air cleaner.

If the current position doesn't match the position on the map, or if the current position cannot be confirmed, the position recognition unit 5240 may estimate the current position based on the map by analyzing the acquired image input from the image acquisition unit 5140.

The position recognition unit 5240 processes the acquired image acquired at each position while the map is generated by the map generation unit 5220, and recognizes the entire area of the main body in association with the map.

The position recognition unit 5240 may determine the current position of the main body by comparing the map with the acquired image for each position on the map by using the acquired image of the image acquisition unit 5140. Therefore, even if the position of the main body suddenly changes, the current position can be estimated and recognized.

The position recognition unit 5240 determines the position by analyzing various features, such as the lightings disposed on the ceiling, edges, corners, blobs, and ridges, which are included in the acquired image. The acquired image may be input from an image acquisition unit or a second image acquisition unit provided at the upper end of the main body.

The position recognition unit 5240 detects a feature from each of the acquired images. Various feature detection methods for detecting the features from the image are well known in the field of computer vision technology. Several feature detectors suitable for the detection of these features are known. For example, there are Canny, Sobel, Harris & Stephens/Plessey, SUSAN. Shi & Tomasi, Level curve curvature, FAST, Laplacian of Gaussian, Difference of Gaussians, Determinant of Hessian, MSER, PCBR, and Gray-level blobs detectors.

The position recognition unit 5240 calculates a descriptor based on each feature. The position recognition unit 5240 may convert the feature into the descriptor by using a scale invariant feature transform (SIFT) technique for feature detection. The descriptor may be represented by an n-dimensional vector. SIFT can detect invariant features for scale, rotation, and brightness changes of the subject. Therefore, even if the same area is photographed with different postures of the robot cleaner 51, the feature that is invariant (i.e., rotation-invariant) may be detected. The present disclosure is not limited thereto, and other various techniques (e.g., HOG: Histogram of Oriented Gradient. Haar feature, Fems, LBP: Local Binary Pattern, MCT: Modified Census Transform) may be applied.

The position recognition unit 5240 may classify at least one descriptor for each acquired image into a plurality of groups according to a predetermined sub-classification rule based on descriptor information acquired through the acquired image of each position, and convert descriptors included in the same group into lower representative descriptors according to a predetermined sub-representative rule. As another example, the position recognition unit 5240 may classify all descriptors collected from acquired images in a predetermined area, such as a room, into a plurality of groups according to a predetermined sub-classification rule, and convert descriptors included in the same group into sub-representative descriptors according to the predetermined lower representative rule.

The position recognition unit 5240 may obtain a feature distribution of each position through the above process. Each position feature distribution can be represented by a histogram or an n-dimensional vector. As another example, the learning module 143 may estimate an unknown current position based on a descriptor calculated from each feature without passing through a predetermined sub-classification rule and a predetermined sub-representative rule.

In addition, if the current position of the robot cleaner 51 becomes unknown due to a position leap or the like, the position recognition unit 5240 may estimate the current position based on previously stored descriptors or sub-representative descriptors.

The position recognition unit 5240 acquires an acquired image through the image acquisition unit 5140 at an unknown current position, and detects features from the acquired image if various features such as lights disposed on the ceiling, edges, corners, blobs, and ridges are identified through the image.

Based on at least one piece of recognition descriptor information acquired from the acquired image at the unknown current position, the position recognition unit 5240 performs conversion into information (sub-recognition feature distribution) to be comparable with position information (for example, the feature distribution of each position) to be compared according to a predetermined sub-conversion rule. According to a predetermined sub-comparison rule, each position feature distribution may be compared with each recognition feature distribution to calculate each similarity. A similarity (probability) may be calculated for each position, and a position where the greatest probability is calculated may be determined as the current position.

If the map is updated by the map generation unit 5220 during traveling, the control unit 5200 transmits the updated information to the air cleaner 300 through the communication unit, so that the maps stored in the air cleaner and the robot cleaner 51 are the same.

If the cleaning command is input, the traveling control unit 5230 controls the driving unit to move to the designated area among the cleaning areas, and operates the cleaning unit to perform cleaning with traveling.

If the cleaning command is input with respect to a plurality of areas, the traveling control unit 5230 may perform cleaning by moving areas according to whether a priority area is set or in a designated order. If no separate order is specified, the traveling control unit 5230 performs cleaning by moving to a near area or an adjacent area based on the distance from the current position.

In addition, if the cleaning command for an arbitrary area is input regardless of the area classification, the traveling control unit 5230 performs cleaning by moving to the area included in the arbitrary area.

If the virtual wall is set, the traveling control unit 5230 determines the virtual wall and controls the driving unit based on the coordinate value input from the map generation unit 5220.

Even if the obstacle recognition unit 5210 determines that the obstacle does not exist, if the virtual wall is set, the traveling control unit 5230 recognizes that the obstacle exists at the corresponding position and restricts the traveling.

If the virtual wall setting changes during traveling, the traveling control unit 5230 classifies a traveling-possible area and a traveling-impossible area according to the changed virtual wall setting and resets the traveling route.

The traveling control unit 5230 controls the traveling in response to any one of setting 1 for the noise, setting 2 for the traveling route, setting 3 for the avoidance, and setting 4 for the security according to the attribute set to the virtual wall.

The traveling control unit 5230 may access the virtual wall to perform a designated operation according to the attribute of the virtual wall (traveling route, setting 2), may reduce the noise occurring from the main body and then perform cleaning (noise, setting 1), may travel while avoiding the virtual wall without approaching the virtual wall more than a certain distance (avoidance, setting 3), and may capture an image of a predetermined area based on the virtual wall (security, setting 4).

If the cleaning of the set designated area is completed, the control unit 5200 stores the cleaning record in the data unit.

In addition, the control unit 5200 transmits the operation state of the robot cleaner 51 or the cleaning state to the air cleaner through the communication unit 190 at a predetermined cycle.

Based on the data received from the robot cleaner 51, the air cleaner displays the position of the robot cleaner together with the map on the screen of the running application, and also outputs information about the cleaning state.

If the information about the obstacle is added, the air cleaner may update the map based on the received data.

If the cleaning command is input, the robot cleaner may travel while dividing the traveling-possible area and the traveling-impossible area based on the information of the set virtual wall.

Meanwhile, the sensor unit 5150 may include a camera. In addition, the control unit 5200 may control the camera to capture the indoor space to thereby acquire the image of the indoor space.

The sensor unit 5150 may include at least one of a laser sensor, an ultrasonic sensor, an infrared sensor, or a camera. The sensor unit 5150 may generate the map of the indoor space by using at least one of images captured by a laser, an ultrasonic wave, an infrared ray, and a camera.

In addition, the sensor unit 5150 may include a temperature sensor for measuring the temperature of the indoor space, a first heat sensor (e.g., an infrared sensor) for detecting the body temperature of the user, and a second heat sensor for detecting heat generation information such as the operation state of the gas range or the electric range, or heat generation of the electronic product.

In addition, the sensor unit 5150 may include a microphone for receiving sound.

In addition, the sensor unit 5150 may include a dust sensor for detecting the amount of dusts in the air and a gas sensor for detecting the amount of gas in the air.

Hereinafter, a moving agent will be described. In one example, the moving agent is described using the above-described robot cleaner as an example, but is not limited thereto. The moving agent may be any apparatus capable of moving in indoor space, such as a pet robot, a guide robot, or the like.

In addition, the moving agent may include the components of the AI apparatus 100, the learning device 200, and the robot cleaner 51 described above, and may perform a function corresponding thereto.

In addition, the term “AI apparatus 100” may be used interchangeably with the term “moving agent 100”. In addition, the term “moving agent 100” may be used interchangeably with the term “artificial intelligence moving agent 100”.

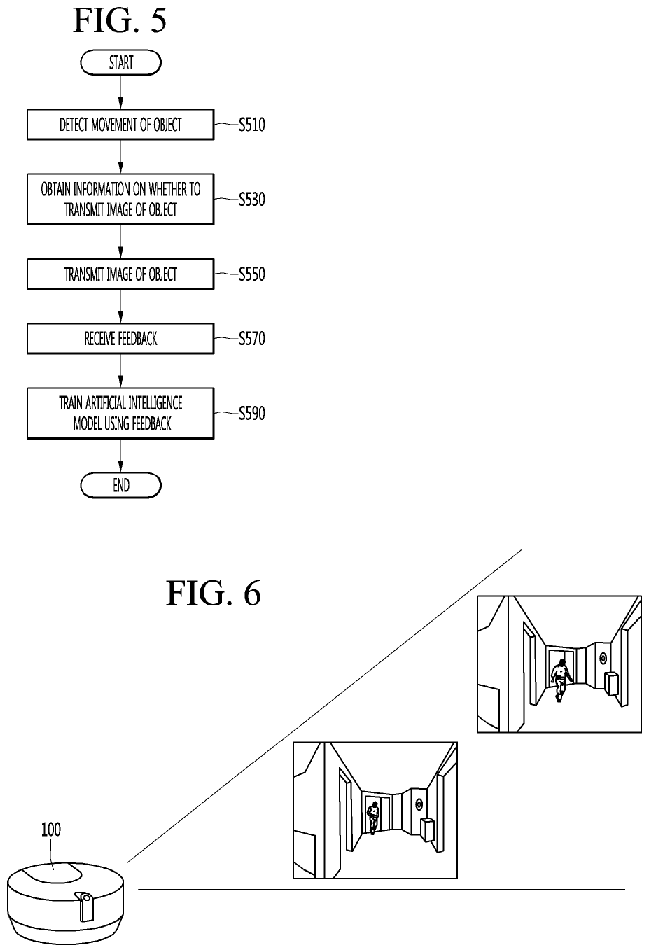

FIG. 5 is a view for illustrating a method for operating a moving agent 100 according to an embodiment of the present disclosure.

The method for operating the moving agent 100 according to an embodiment of the present disclosure may include detecting a movement of an object (S510), providing an image of the object to an artificial intelligence model to obtain information on whether to transmit the image of the object when the movement of the object is detected (S530), transmitting the image of the object to a terminal based on the obtained information (S550), receiving feedback corresponding to the image of the object from the terminal (S570), and training the artificial intelligence model using the feedback (S590).

First, S510 will be described with reference to FIG. 6.

FIG. 6 is a diagram for illustrating a method for detecting a movement of an object and obtaining an image.

The processor 180 may detect the movement of the object.

Specifically, the processor 180 may obtain the image of the movement of the object and detect the movement of the object using the obtained image.

More specifically, the processor may obtain a video of the movement of the object. In this case, the video may include a plurality of frames, and the processor may obtain information on whether the object is moving using a location, a shape, or the like of the object included in the plurality of frames.

In another way, the processor may obtain a plurality of still images of the movement of the object. Further, the processor may obtain information on whether the object moves using a location, a shape, or the like of the object included in the plurality of still images.

In one example, in addition to the camera, known means for detecting the movement of the object may be used to detect the movement of the object.

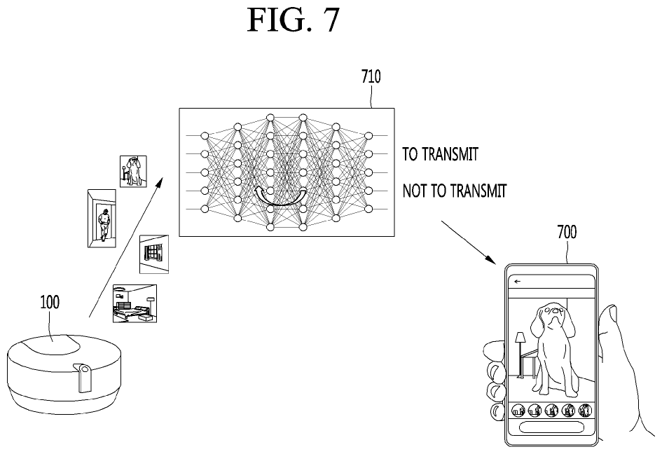

In one example, when the movement of the object is detected, the processor may provide the image of the object to the artificial intelligence model to obtain information on whether to transmit the image of the object. This will be described with reference to FIG. 7.

First, the artificial intelligence will be briefly described.

Artificial intelligence (AI) is one field of computer engineering and information technology for studying a method of enabling a computer to perform thinking, learning, and self-development that can be performed by human intelligence and may denote that a computer imitates an intelligent action of a human.

Moreover, AI is directly/indirectly associated with the other field of computer engineering without being individually provided. Particularly, at present, in various fields of information technology, an attempt to introduce AI components and use the AI components in solving a problem of a corresponding field is being actively done.

Machine learning is one field of AI and is a research field which enables a computer to perform learning without an explicit program.

In detail, machine learning may be technology which studies and establishes a system for performing learning based on experiential data, performing prediction, and autonomously enhancing performance and algorithms relevant thereto. Algorithms of machine learning may use a method which establishes a specific model for obtaining prediction or decision on the basis of input data, rather than a method of executing program instructions which are strictly predefined.

The term “machine learning” may be referred to as “machine learning”.

In machine learning, a number of machine learning algorithms for classifying data have been developed. Decision tree, Bayesian network, support vector machine (SVM), and artificial neural network (ANN) are representative examples of the machine learning algorithms.

The decision tree is an analysis method of performing classification and prediction by schematizing a decision rule into a tree structure.

The Bayesian network is a model where a probabilistic relationship (conditional independence) between a plurality of variables is expressed as a graph structure. The Bayesian network is suitable for data mining based on unsupervised learning.

The SVM is a model of supervised learning for pattern recognition and data analysis and is mainly used for classification and regression.

The ANN is a model which implements the operation principle of biological neuron and a connection relationship between neurons and is an information processing system where a plurality of neurons called nodes or processing elements are connected to one another in the form of a layer structure.

The ANN is a model used for machine learning and is a statistical learning algorithm inspired from a neural network (for example, brains in a central nervous system of animals) of biology in machine learning and cognitive science.

In detail, the ANN may denote all models where an artificial neuron (a node) of a network which is formed through a connection of synapses varies a connection strength of synapses through learning, thereby obtaining an ability to solve problems.

The term “ANN” may be referred to as “neural network”.

The ANN may include a plurality of layers, and each of the plurality of layers may include a plurality of neurons. Also, the ANN may include a synapse connecting a neuron to another neuron.

The ANN may be generally defined by the following factors: (1) a connection pattern between neurons of a different layer; (2) a learning process of updating a weight of a connection; and (3) an activation function for generating an output value from a weighted sum of inputs received from a previous layer.

The ANN may include network models such as a deep neural network (DNN), a recurrent neural network (RNN), a bidirectional recurrent deep neural network (BRDNN), a multilayer perceptron (MLP), and a convolutional neural network (CNN), but is not limited thereto.

In this specification, the term “layer” may be referred to as “layer”.

The ANN may be categorized into single layer neural networks and multilayer neural networks, based on the number of layers.

General single layer neural networks is configured with an input layer and an output layer.

Moreover, general multilayer neural networks is configured with an input layer, at least one hidden layer, and an output layer.

The input layer is a layer which receives external data, and the number of neurons of the input layer is the same the number of input variables, and the hidden layer is located between the input layer and the output layer and receives a signal from the input layer to extract a characteristic from the received signal and may transfer the extracted characteristic to the output layer. The output layer receives a signal from the hidden layer and outputs an output value based on the received signal. An input signal between neurons may be multiplied by each connection strength (weight), and values obtained through the multiplication may be summated. When the sum is greater than a threshold value of a neuron, the neuron may be activated and may output an output value obtained through an activation function.

The DNN including a plurality of hidden layers between an input layer and an output layer may be a representative ANN which implements deep learning which is a kind of machine learning technology.

The term “deep learning” may be referred to as “deep learning”.

The ANN may be trained by using training data. Here, training may denote a process of determining a parameter of the ANN, for achieving purposes such as classifying, regressing, or clustering input data. A representative example of a parameter of the ANN may include a weight assigned to a synapse or a bias applied to a neuron.

An ANN trained based on training data may classify or cluster input data, based on a pattern of the input data.

In this specification, an ANN trained based on training data may be referred to as a trained model.

Next, a learning method of an ANN will be described.

The learning method of the ANN may be largely classified into supervised learning, unsupervised learning, semi-supervised learning, and reinforcement learning.

The supervised learning may be a method of machine learning for analogizing one function from training data.

Moreover, in analogized functions, a function of outputting continual values may be referred to as regression, and a function of predicting and outputting a class of an input vector may be referred to as classification.

In the supervised learning, an ANN may be trained in a state where a label of training data is assigned.

Here, the label may denote a right answer (or a result value) to be inferred by an ANN when training data is input to the ANN.

In this specification, a right answer (or a result value) to be inferred by an ANN when training data is input to the ANN may be referred to as a label or labeling data.

Moreover, in this specification, a process of assigning a label to training data for learning of an ANN may be referred to as a process which labels labeling data to training data.

In this case, training data and a label corresponding to the training data may configure one training set and may be inputted to an ANN in the form of training sets.

Training data may represent a plurality of features, and a label being labeled to training data may denote that the label is assigned to a feature represented by the training data. In this case, the training data may represent a feature of an input object as a vector type.

An ANN may analogize a function corresponding to an association relationship between training data and labeling data by using the training data and the labeling data. Also, a parameter of the ANN may be determined (optimized) through evaluating the analogized function.

The unsupervised learning is a kind of machine learning, and in this case, a label may not be assigned to training data.

In detail, the unsupervised learning may be a learning method of training, an ANN so as to detect a pattern from training data itself and classify the training data, rather than to detect an association relationship between the training data and a label corresponding to the training data.

Examples of the unsupervised learning may include clustering and independent component analysis.

In this specification, the term “clustering” may be referred to as “clustering”.

Examples of an ANN using the unsupervised learning may include a generative adversarial network (GAN) and an autoencoder (AE).

The GAN is a method of improving performance through competition between two different AIs called a generator and a discriminator.

In this case, the generator is a model for creating new data and generates new data, based on original data.

Moreover, the discriminator is a model for recognizing a pattern of data and determines whether inputted data is original data or fake data generated from the generator.

Moreover, the generator may be trained by receiving and using data which does not deceive the discriminator, and the discriminator may be trained by receiving and using deceived data generated by the generator. Therefore, the generator may evolve so as to deceive the discriminator as much as possible, and the discriminator may evolve so as to distinguish original data from data generated by the generator.

The AE is a neural network for reproducing an input as an output.

The AE may include an input layer, at least one hidden layer, and an output layer.

In this case, the number of node of the hidden layer may be smaller than the number of nodes of the input layer, and thus, a dimension of data may be reduced, whereby compression or encoding may be performed.

Moreover, data outputted from the hidden layer may enter the output layer. In this case, the number of nodes of the output layer may be larger than the number of nodes of the hidden layer, and thus, a dimension of the data may increase, and thus, decompression or decoding may be performed.

The AE may control the connection strength of a neuron through learning, and thus, input data may be expressed as hidden layer data. In the hidden layer, information may be expressed by using a smaller number of neurons than those of the input layer, and input data being reproduced as an output may denote that the hidden layer detects and expresses a hidden pattern from the input data.

The semi-supervised learning is a kind of machine learning and may denote a learning method which uses both training data with a label assigned thereto and training data with no label assigned thereto.

As a type of semi-supervised learning technique, there is a technique which infers a label of training data with no label assigned thereto and performs learning by using the inferred label, and such a technique may be usefully used for a case where the cost expended in labeling is large.

The reinforcement learning may be a theory where, when an environment where an agent is capable of determining an action to take at every moment is provided, the best way is obtained through experience without data.

The reinforcement learning may be performed by a Markov decision process (MDP).

To describe the MDP, firstly an environment where pieces of information needed for taking a next action of an agent may be provided, secondly an action which is to be taken by the agent in the environment may be defined, thirdly a reward provided based on a good action of the agent and a penalty provided based on a poor action of the agent may be defined, and fourthly an optimal policy may be derived through experience which is repeated until a future reward reaches a highest score.

A structure of the artificial neural network may be specified by a model composition, an activation function, a loss function or cost function, a learning algorithm, an optimization algorithm, or the like, a hyperparameter may be preset before learning, and then a model parameter is set through the learning to specify a model.

For example, elements for determining the structure of the artificial neural network may include the number of hidden layers, the number of hidden nodes included in each hidden layer, an input feature vector, a target feature vector, and the like.

The hyperparameter includes various parameters that must be set initially for the learning, such as an initial value or the like of the model parameter. In addition, the model parameter includes various parameters to be determined through the learning.

For example, the hyperparameter may include an initial weight value between nodes, an initial bias value between nodes, a mini-batch size, the number of the learning repetitions, a learning rate, or the like. In addition, the model parameter may include a weight value between nodes, a bias value between nodes, or the like.

The loss function can be used for an index (reference) for determining optimum model parameters in a training process of an artificial neural network. In an artificial neural network, training means a process of adjusting model parameters to reduce the loss function and the object of training can be considered as determining model parameters that minimize the loss function.

The loss function may mainly use a mean squared error (MSE) or a cross entropy error (CEE), but the present disclosure is not limited thereto.

The CEE may be used when a correct answer label is one-hot encoded. One-hot encoding is an encoding method for setting a correct answer label value to 1 for only neurons corresponding to a correct answer and setting a correct answer label to 0 for neurons corresponding to a wrong answer.

A learning optimization algorithm may be used to minimize a loss function in machine learning or deep learning, as the learning optimization algorithm, there are Gradient Descent (GD), Stochastic Gradient Descent (SGD), Momentum, NAG (Nesterov Accelerate Gradient), Adagrad, AdaDelta, RMSProp, Adam, and Nadam.

The GD is a technique that adjusts model parameters such that a loss function value decreases in consideration of the gradient of a loss function in the current state.

The direction of adjusting model parameters is referred to as a step direction and the size of adjustment is referred to as a step size.

In this case, the step size may mean the learning rate.

The gradient descent scheme may obtain a slope by partial-differentiate the loss function with each model parameter, and may change the model parameters by the learning rate in an obtained gradient direction to update the model parameters.

The SGD is a technique that increases the frequency of gradient descent by dividing training data into mini-batches and performing the GD for each of the mini-batches.

The Adagrad, AdaDelta, and RMSProp in the SGD are techniques that increase optimization accuracy by adjusting the step size. The momentum and the NAG in the SGD are techniques that increase optimization accuracy by adjusting the step direction. The Adam is a technique that increases optimization accuracy by adjusting the step size and the step direction by combining the momentum and the RMSProp. The Nadam is a technique that increases optimization accuracy by adjusting the step size and the step direction by combining the NAG and the RMSProp.

The learning speed and accuracy of an artificial neural network greatly depends on not only the structure of the artificial neural network and the kind of a learning optimization algorithm, but the hyperparameters. Accordingly, in order to acquire a good trained model, it is important not only to determine a suitable structure of an artificial neural network, but also to set suitable hyperparameters.

In general, hyperparameters are experimentally set to various values to train an artificial neural network, and are set to optimum values that provide stable learning speed and accuracy using training results.

In one example, an artificial intelligence model 710 according to an embodiment of the present disclosure may be a neural network that is trained to predict whether to transmit the image.

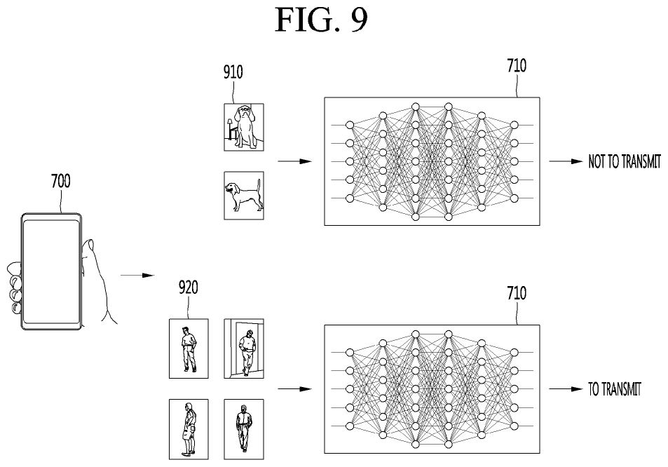

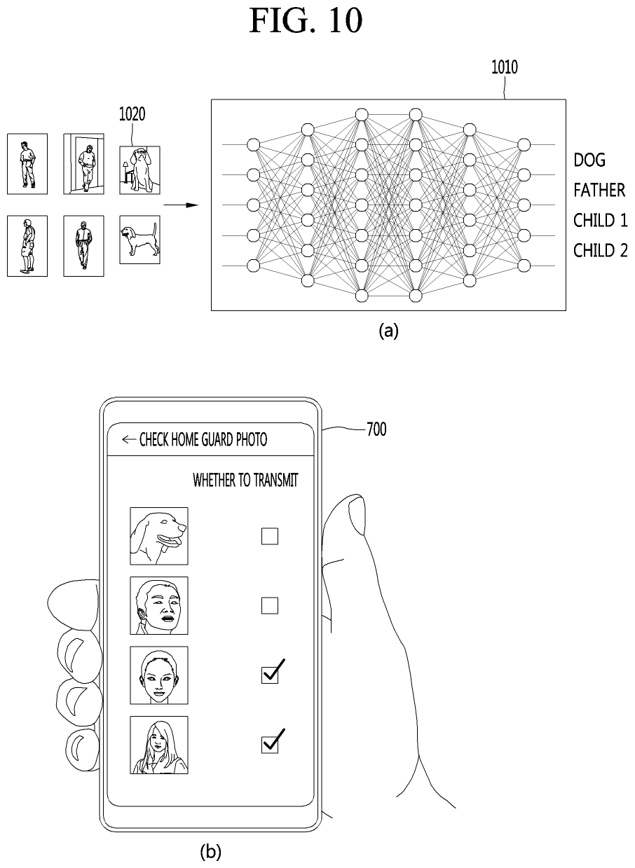

A method for training the artificial intelligence model 710 will be described in detail with reference to FIG. 9. FIG. 7 illustrates an operation of the moving agent under the premise that the artificial intelligence model 710 is trained.

The processor 180 may provide the artificial intelligence model with the image of the object.

The image of the object may be an image shooted to detect the movement of the object or may be an image newly shooted by the processor via the camera after the movement of the object is detected.

In addition, the image shooted the object may be a video including a plurality of frames.

In addition, the image shooted the object may be a single still image or a plurality of still images shooted the movement of the object.

In one example, the image of the object may include a feature vector for determining whether to transmit the image. In this connection, the feature vector may represent at least one of a kind of the object, the movement of the object, and a detailed classification of the object.

In this connection, the type of object may include a person, a pet, a curtain, a change of light, and the like.

In addition, the movement of the object may include a moving pattern of the object.

In addition, the detailed classification of the object is a further subdivision of the kinds of the object. When a person is used as an example, the detailed classification of the object may be a father, a mother, a child, a kid, an adult, a family, a household member, an outsider, or the like.

In one example, when the video or the plurality of still images are input, the movement of the object may be extracted by the artificial intelligence model 710.

In one example, the image input to the artificial intelligence model 710 may not necessarily match the image shooted the object.

For example, when the video of the plurality of frames shooted the object is obtained, the processor may input some of the plurality of frames into the artificial intelligence model 710.

In another example, when the plurality of still images of the object are obtained, the processor may input some of the plurality of still images into the artificial intelligence model 710.

In one example, when the image of the object is input, the artificial intelligence model may obtain a result value, specifically, the information on whether to transmit the image of the object.

In this connection, the information on whether to transmit the image of the object may include to transmit the image of the object and not to transmit the image of the object.

In one example, when the information on whether to transmit the image of the object is obtained, the processor may transmit the image of the object to the terminal via a communication unit based on the obtained information.

Specifically, when the information on whether to transmit the image of the object is “not to transmit”, the processor may not transmit the image of the object to the terminal.

On the other hand, when the information on whether to transmit the image of the object is “to transmit”, the processor may transmit the image of the object to the terminal.

In this connection, transmitting the image of the object to the terminal may mean transmitting the same image as the image input into the artificial intelligence model 710 or may also mean transmitting an image partially different from the image input into the artificial intelligence model 710.

Specifically, when the video is input into the artificial intelligence model 710 and the information of “to transmit” is obtained, the processor may transmit some of the plurality of frames of the video to the terminal.

Further, when the plurality of still images are input into the artificial intelligence model 710 and the information of “to transmit” is obtained, the processor may transmit some of the plurality of still images to the terminal.

Further, when the video of the plurality of frames containing the object is shooted, some of the plurality of frames are input into the artificial intelligence model 710, and the information of “to transmit” is obtained, the processor may transmit the video of the plurality of frames to the terminal.

Further, when the plurality of still images containing the object are shooted, some images of the plurality of still images are input into the artificial intelligence model 710, and the information of “to transmit” is obtained, the processor may transmit the plurality of still images to the terminal.

In one example, the processor 180 may store the image of the object in a memory.

In one example, the processor may transmit identification information corresponding to the image of the object to the terminal together with the image of the object.

For example, the processor may transmit, together with a first image, first identification information corresponding to the first image to the terminal. In addition, the processor may transmit, together with a second image, second identification information corresponding to the second image to the terminal.

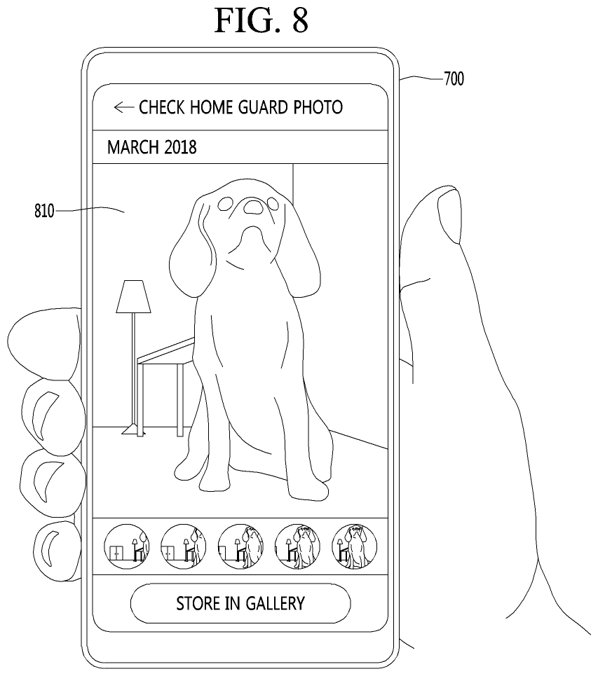

Next, an operation of the terminal will be described with reference to FIG. 8.

FIG. 8 is a diagram for illustrating a method for transmitting feedback of a terminal according to an embodiment of the present disclosure.

In one example, the terminal 700 may include the components of the AI apparatus 100 described with reference to FIG. 1 and perform a function of a corresponding component.

Referring to FIG. 8, the processor of the terminal 700 may receive the image of the object via the communication unit.

In this case, the processor of the terminal may display an image 810 of the object.

In addition, the processor of the terminal may generate feedback based on a user's response.

In this connection, the feedback may be information on whether to transmit the image of the object.

Specifically, when an input for storing the image 810 of the object is received in a state in which the image 810 of the object is displayed, the processor of the terminal may generate feedback including the information of “to transmit”.

In another example, when an input for deleting the image 810 of the object is received in a state in which the image 810 of the object is displayed, the processor of the terminal may generate feedback including the information of “not to transmit”.

Further, the feedback may be generated in a variety of ways.

For example, when the user does not see an image of an object stored in the memory for a preset period of time, the processor of the terminal may generate feedback including information of not to transmit the image of the object stored in the memory.

In another example, when the user smiling while looking at the displayed image 810 of the object is detected, the processor of the terminal may generate feedback including information of to transmit the displayed image 810 of the object.

In another example, the processor of the terminal may receive an input for setting whether to transmit the image of the object via an input interface. In this case, the processor may generate the feedback based on the received input.

In one example, the processor of the terminal may transmit feedback corresponding to the image of the object to the moving agent 100.

Specifically, it is assumed that identification information of the first image is received together with the first image of the object from the moving agent. In this case, the processor may generate a first feedback based on a user's response to the first image and transmit the generated first feedback to the moving agent 100.

In one example, the feedback may include identification information corresponding to the image of the object together with the information on whether to transmit the image of the object.

Specifically, it is assumed that the identification information of the first image is received together with the first image of the object from the moving agent. In this case, the processor may transmit feedback including the information on whether to transmit the first image and the identification information of the first image to the moving agent.

In one example, the processor 180 of the moving agent 100 may receive the feedback corresponding to the image of the object from the terminal 700 and train the artificial intelligence model 710 using the feedback.

This will be described with reference to FIG. 9.

FIG. 9 illustrates a method for training an artificial intelligence model according to an embodiment of the present disclosure.

The processor 180 may train the artificial intelligence model by labeling the feedback on the image of the object using a supervised learning method.

Specifically, the processor 180 may use the image of the object as an input value and use the feedback corresponding to the image of the object as an output value to train the artificial intelligence model 710.

In this connection, the feedback may include the information on whether to transmit the image of the object and whether to transmit the image of the object may be a correct answer to be inferred using the input image by the artificial intelligence model 710.

More specifically, when feedback corresponding to a first image 910 of an object is “not to transmit”, the processor 180 may label information of “not to transmit” on the first image 910 of the object to train the artificial intelligence model 710.

On the other hand, when feedback corresponding to a second image 920 of an object is “to transmit”, the processor 180 may label information of “to transmit” on the second image 920 of the object to train the artificial intelligence model 710.

In this case, the artificial intelligence model 710 may use the image of the object and the information on whether to transmit the image of the object to infer a function of correlation between the image of the object and the information on whether to transmit the image of the object. Through an evaluation of the function inferred from the neural network, the parameters (weight, bias, or the like) of the neural network may be determined (optimized).

In one example, the identification information included in the feedback information and the identification information of the image captured by the object.

Specifically, when transmitting the first image of the object to the terminal 100, the processor 180 may transmit first identification information corresponding to the first image together with the first image of the object. In addition, the processor 180 may store the first image of the object and the first identification information corresponding to the first image in the memory.

Further, when the first feedback including the information on whether to transmit the image of the object and the first identification information is received, the processor may label the information on whether to transmit the image of the object included in the first feedback on the first image of the object stored in the memory to train the artificial intelligence model 710.

Further, when the movement of the object is detected again, the processor may provide the image of the object to the trained artificial intelligence model 710 to obtain the information on whether to transmit the image of the object and transmit the image of the object to the terminal based on the obtained information.

Recently, a robot cleaner that serves as a CCTV inside a house through a mounted camera is commercially available. Further, the robot cleaner transmits an image to a terminal of a user when a movement of an object is detected. However, the transmitted images may include a plurality of images that the user does not desire to receive.

Further, according to the present disclosure, the robot cleaner first determines whether the shooted images are images that the user desires and then selects the images and transmits the selected images to the terminal, thereby preventing undesired images from being transmitted.

In addition, since the artificial intelligence model is retrained using the feedback based on the user's response, which image the user desires to receive or which image the user does not desire to receive may be exactly determined.

For example, when the user has persistently stored images of a dog in the memory, the artificial intelligence model may be trained to output a result value of “to transmit” when the image of the dog is input.

In another example, when the user provides an input to transmit an image of an outside to the terminal, the artificial intelligence model may be trained to output a result value of “to transmit” when an image containing a person other than a family who was shooted frequently.

In another example, when the user consistently deleted an image of the family, the artificial intelligence model may be trained to output a result value of “not to transmit” when the image of the family is input.

In another example, when the user sees an image of a child approaching a stove or the child operating the stove and then provides an input, to the terminal, to transmit such image, the terminal may transmit the image and feedback (“to transmit”) corresponding to the image to the moving agent. In this case, the artificial intelligence model may be trained to output a result value of “to transmit” when the image of the child approaching the stove or operating the stove is input.

Further, according to the present disclosure, since the artificial intelligence model is continuously trained using the feedback based on the user's response, the more the moving agent is used, the more optimized service may be provided to the user.

In one example, the processor may not only transmit the image of the object to the terminal but also store the image of the object in the memory.

Further, when the feedback corresponding to the stored image of the object is received, the artificial intelligence model may be trained by labeling the feedback received on the stored image of the object.

Further, after training the artificial intelligence model, the processor may delete the image of the object from the memory.

When the moving agent transmits a plurality of images to the terminal, many images are stored in the memory, which causes insufficient storage space. However, according to the present disclosure, shortage of the storage space of the memory may be prevented by deleting the image used as the training data from the memory.

In one example, the present disclosure uses the image shooted by the moving agent as the training data for training the artificial intelligence model and uses the feedback received from the terminal as the labeling data for the training data.

However, this method takes time to accumulate the training data, which may cause the training of the artificial intelligence model 710 to proceed slowly.

Therefore, the artificial intelligence model 710 according to the present disclosure may be the neural network that is pre-trained to extract the feature vector.

In this case, the feature vector may include at least one of the kind of the object, the movement of the object, and a detailed classification of the object.

Specifically, the learning device 200 may train the neural network to extract the feature vector for determining the kind of the object using images of various kinds of objects as the training data. More specifically, the learning device 200 may provide the image of the person, the pet, the curtain, or the like to the neural network as the training data. In this case, the neural network may set the model parameter to extract the feature vector for determining the kind of the object.

In addition, the learning device 200 may train the neural network to extract the feature vector for determining the movement of the object using images of objects of various movements as the training data. More specifically, the learning device 200 may provide the neural network with a suspicious motion, a running motion, a sleeping motion, a motion of approaching the stove of the person, an active motion of the pet, or the like as the training data. In this case, the neural network may set the model parameter to extract the feature vector for determining the movement of the object.

In addition, the learning device 200 may train the neural network to extract the feature vector for determining the detailed classification of the object using images of various detailed classifications as the training data. For example, the learning device 200 may provide images of various people (adult, man, woman, grandfather, child, and infant) to the neural network as the training data. In this case, the neural network may set the model parameter to extract the feature vector for determining the detailed classification of the object.

In one example, the pre-trained neural network may be mounted on the moving agent. The neural network thus trained may be referred to as the artificial intelligence model 710.

Further, the artificial intelligence model may be implemented in hardware, software, or a combination of the hardware and the software. Further, when a portion or an entirety of the artificial intelligence model is implemented in the software, at least one instruction constituting the artificial intelligence model may be stored in the memory 170 of the moving agent.

In one example, the artificial intelligence model 710 may infer whether to transmit the image using the input image. Further, in an inference process, the artificial intelligence model 710 may extract the feature vector of the input image and use the extracted feature vector to infer whether to transmit the image.

As such, according to the present disclosure, the artificial intelligence model 710 is previously trained to extract the feature vector to increase a training speed to be suitable for the usage environment after the artificial intelligence model 710 is installed.

In one example, the training data may be provided from the terminal of the user.

Specifically, based on the input of the user, the processor of the terminal may transmit the image containing the object and the information on whether to transmit the image containing the object to the moving agent. More specifically, the processor of the terminal may receive an input of selecting the image containing the object and an input of whether to transmit the selected image and transmit the selected image and the information on whether to transmit the selected image to the moving agent.

In this case, the processor of the moving agent may receive the image containing the object and the information on whether to transmit the image containing the object from the terminal. Further, the processor of the moving agent may train the artificial intelligence model using the image containing the object and the information on whether to transmit the image containing the object.

As such, according to the present disclosure, in addition to the image shooted by the moving agent, the user may additionally provide the training data to train the artificial intelligence model.

In one example, when the artificial intelligence model 710 is initially mounted on the moving agent, the artificial intelligence model 710 may be in a state in which a parameter is set to output only a result value of “to transmit”.

In this case, the artificial intelligence model 710 may be trained using the image of the object and labeling data of “not to transmit” to be evolved to select an image and transmit the selected image to the terminal.

In one example, the artificial intelligence model 710 may include a plurality of models respectively corresponding to a plurality of users.

For example, the artificial intelligence model 710 may include a first model corresponding to a father, a second model corresponding to a mother, and a third model corresponding to a son among family members.

In this case, the processor 180 may provide the image of the object to the first model, the second model, and the third model.

In addition, the processor 180 may obtain a plurality of information on whether to transmit the image of the object respectively corresponding to the plurality of users.

For example, the processor 180 may obtain information about “to transmit” output from the first model, “not to transmit” output from the second model, and “to transmit” output from the third model.

In this case, the processor 180 may transmit the image of the object to at least one of the plurality of terminals respectively corresponding to the plurality of models based on the obtained plurality of information.

For example, when the information of “to transmit” is output from a first model, the processor 180 may transmit the shooted image to the first terminal (a terminal of the father) corresponding to a first model.

In another example, when the information of “not to transmit” is output from a second model, the processor 180 may not transmit the shooted image to the second terminal (a terminal of the mother) corresponding to a second model.

In another example, when the information of “to transmit” is output from a third model, the processor 180 may transmit the shooted image to the third terminal (a terminal of the son) corresponding to a third model.

In one example, the processor 180 may train a model corresponding to a terminal transmitted feedback using the feedback received from the terminal.

For example, when feedback including the information of “to transmit” is received from the first terminal, the processor 180 may train the first model corresponding to the first terminal using the image of the object and the feedback received from the first terminal.

In another example, when feedback including the information of “not to transmit” is received from the third terminal, the processor 180 may train the third model corresponding to the third terminal using the image of the object and the feedback received from the third terminal.

As such, according to the present disclosure, since image classification and model training are individually performed for each user, a personalized service may be provided to each of the plurality of users.

In one example, earlier, it has been described that the artificial intelligence model is trained in a supervised learning scheme. However, the present disclosure is not limited thereto, and the artificial intelligence model may be trained in a reinforcement learning scheme.

The reinforcement learning may be mainly performed by a Markov decision process (MDP).

To describe the MDP, firstly an environment where pieces of information needed for taking a next action of an agent may be provided, secondly an action which is to be taken by the agent in the environment based on a state may be defined, thirdly it may be defined to provide a reward based on a good action of the agent and to provide a penalty based on a poor action of the agent, and fourthly an optimal policy may be derived through experience which is repeated until a future reward reaches a highest score.

Applying the Markov decision process to the present disclosure, the agent may mean the moving agent, more specifically, the artificial intelligence model.

Further, first, in the present disclosure, an environment where the pieces of the information needed for taking the next action of the agent (artificial intelligence model), that is, the image of the object may be provided.

Further, secondly, in the present disclosure, the action which is to be taken by the agent (artificial intelligence mode) based on the provided state (that is, the image of the object), that is, whether to transmit the image may be determined.

Further, thirdly, it may be defined to provide the reward when the image is transmitted to the agent (artificial intelligence model) based on the user's intention and to provide the penalty when the image is transmitted in opposition to the user's intention.

In this case, the agent (artificial intelligence model) may update the parameters of the neural network based on at least one of the reward and the penalty.

Further, fourthly, the optimal policy, that is, a transmission policy of the image that meets the user's intention may be derived through the experience which is repeated until the future reward reaches the highest score.

Specifically, the processor may receive the feedback from the terminal. In this connection, the feedback may include positive feedback or negative feedback.

Specifically, when the image transmitted from the moving agent to the user is an image that the user desires to receive, for example, when the user provides input for storing the image, when the user laughing while looking at the image is detected, or when an input of setting the transmission of the image is received, the terminal may transmit the positive feedback to the moving agent.

Further, when the image transmitted from the moving agent to the user is an image that the user does not desire to receive, for example, when the user provides an input for deleting the image, when the user does not see the image again for a certain period of time, or when an input of setting non-transmission of the image is received, the terminal may transmit the negative feedback to the moving agent.

In this case, the processor of the moving agent may assign the reward or the penalty to the artificial intelligence model based on the feedback to train the artificial intelligence model in the reinforcement learning scheme.

Specifically, the processor may assign the reward to the artificial intelligence model when the positive feedback is received and may assign the penalty to the artificial intelligence model when the negative feedback is received.

In this case, the artificial intelligence model may be trained again using the positive or negative feedback to establish new policy.

FIG. 10 is a diagram for illustrating a method for receiving an input for setting whether to transmit an image from a terminal according to an embodiment of the present disclosure.

An artificial intelligence model 1010 for clustering the object may be mounted on the terminal.

In this connection, the artificial intelligence model 1010 for clustering the object may be a neural network in which a parameter is set to find a pattern from training data and cluster the training data based on the pattern.

Further, the processor of the terminal may provide a plurality of images stored in the memory of the terminal to the artificial intelligence model 1010 for clustering the object.

In this case, the artificial intelligence model 1010 for clustering the object may cluster and output the plurality of images into a plurality of clusters.

For example, a first cluster may include images containing the dog, a second cluster may include images containing the father, a third cluster may include images containing the mother, and a fourth cluster may include images containing a daughter.

In this case, as shown in FIG. 10B, the processor of the terminal may display a list of a plurality of clusters.

When an input of selecting a specific cluster among the plurality of clusters is received, the processor of the terminal may transmit information about the specific cluster to the moving agent.

In this connection, the information on the specific cluster may be the feedback described above. That is, the processor of the terminal may transmit feedback including identification information of a plurality of images included in the specific cluster and information of “not to transmit” to the moving agent.

In addition, the processor of the terminal may transmit feedback including the plurality of images included in the specific cluster and the information of “not to transmit” to the moving agent.

In one example, the processor of the moving agent may train the artificial intelligence model using the received feedback and an image corresponding to the feedback.

For example, when the cluster representing the father is selected, the processor of the terminal may transmit feedback (to transmit) about the images containing the father to the moving agent. Then, the processor of the moving agent may train the artificial intelligence model using the received feedback and the image corresponding to the feedback. Accordingly, the artificial intelligence model may be trained to output a result value of “to transmit” when the image containing the father is received.

In another example, when the cluster representing the dog is selected, the processor of the terminal may transmit feedback (not to transmit) about the images containing the dog to the moving agent. Then, the processor of the moving agent may train the artificial intelligence model using the received feedback and an image corresponding to the feedback.

Accordingly, the artificial intelligence model may be trained to output a result value of “not to transmit” when the image containing the dog is received.

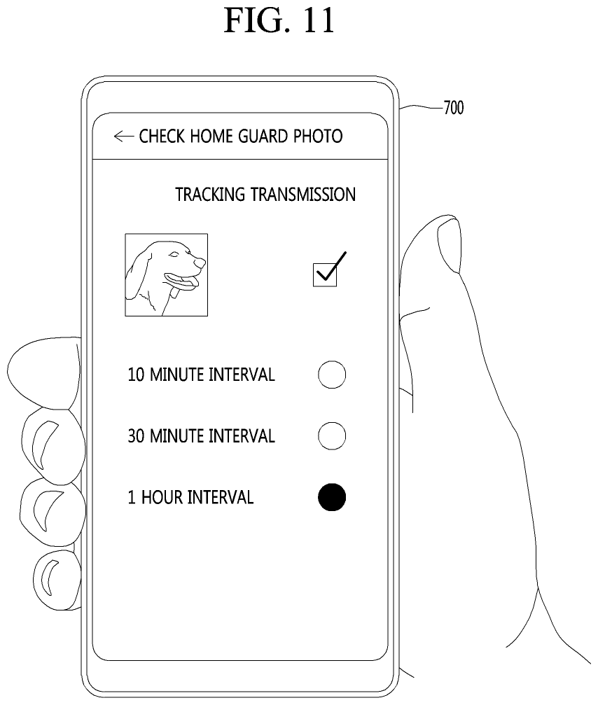

FIG. 11 is a diagram for illustrating a method for tracking an object desired by a user according to an embodiment of the present disclosure.

The user may provide, to the terminal, an input of designating at least one image containing an object, which is desired to be tracked. In this case, the processor of the terminal may input at least one designated image into the artificial intelligence model 1010 for clustering the object to obtain information about a cluster of the object desired to be tracked by the user.

For example, when the user specifies three images that contain the dog, the processor of the terminal may input the three images containing the dog into the artificial intelligence model 1010 to obtain information indicating that the cluster of the object desired to be tracked by the user is a first cluster corresponding to the dog.

In this case, the processor of the terminal may transmit information about the first cluster to the moving agent.

In one example, the processor of the terminal may receive an input of setting a transmission period of the image from the user and transmit the transmission period of the image to the moving agent.

In one example, the moving agent may shoot the image and determine whether an object corresponding to the first cluster is contained in the shooted image.

Further, when the object corresponding to the first cluster is contained in the shooted image, the processor of the moving agent may control the driving unit to track the object. Further, the processor of the moving agent may shoot the object while tracking the object and transmit the shooted image to the terminal.

In this case, the processor of the moving agent may shoot the object based on the transmission period of the image and transmit the image shooted based on the transmission period to the terminal.

The present disclosure described above may be implemented as a computer-readable code in a medium where a program is recorded. A computer-readable medium includes all kinds of recording devices that store data that may be read by a computer system. Examples of the computer-readable medium may include hard disk drive (HDD), solid state drive (SSD), silicon disk drive (SDD), read-only memory (ROM), random access memory (RAM), CD-ROM, a magnetic tape, a floppy disk, an optical data storage device, and the like. Further, the computer may include a controller 180 of the terminal. Accordingly, the detailed description should not be construed as being limited in all respects but should be considered as illustrative. The scope of the present disclosure should be determined by reasonable interpretation of the appended claims, and all changes within the equivalent scope of the present disclosure are included in the scope of the present disclosure.

What is claimed is:

1. An artificial intelligence moving agent comprising:
a communicator in communication with a terminal of a user;
a camera for shooting an image; and
a processor for detecting a movement of an object, providing an image of the object to an artificial intelligence model to obtain information on whether to transmit the image of the object when the movement of the object is detected, and transmitting the image of the object to the terminal based on the obtained information.

2. The artificial intelligence moving agent of claim 1, wherein the processor receives feedback corresponding to the image of the object from the terminal and trains the artificial intelligence model using the feedback, and
wherein the feedback is the information on whether to transmit the image of the object.

3. The artificial intelligence moving agent of claim 2, wherein the processor trains the artificial intelligence model by labeling the feedback on the image of the object, using a supervised learning scheme.

4. The artificial intelligence moving agent of claim 3, further comprising a memory for storing data,
wherein the processor stores the image of the object in the memory, labels the feedback on the image of the object to train the artificial intelligence model when the feedback is received, and deletes the image of the object from the memory after training the artificial intelligence model.

5. The artificial intelligence moving agent of claim 3, wherein the processor transmits identification information corresponding to the image of the object to the terminal together with the image of the object, receives the feedback including the identification information from the terminal, and uses the identification information to label the feedback on the image of the object to train the artificial intelligence model.

6. The artificial intelligence moving agent of claim 3, wherein the processor receives the image containing the object and the information on whether to transmit the image containing the object from the terminal and uses the image containing the object and the information on whether to transmit the image containing the object to train the artificial intelligence model.

7. The artificial intelligence moving agent of claim 2, wherein the processor assigns a reward or a penalty to the artificial intelligence model based on the feedback to train the artificial intelligence model using a reinforcement learning scheme.

8. The artificial intelligence moving agent of claim 1, wherein the image of the object is one of a still image, a video including a plurality of frames, and a plurality of still images.

9. The artificial intelligence moving agent of claim 1, wherein the artificial intelligence model is a neural network pre-trained to extract a feature vector including at least one of a kind of the object, the movement of the object, or a detailed classification of the object.

10. The artificial intelligence moving agent of claim 1, wherein the artificial intelligence model includes a plurality of models respectively corresponding to a plurality of users, wherein the processor provides the image of the object to the plurality of models to obtain a plurality of information on whether to transmit the image of the object and transmits the image of the object to at least one of a plurality of terminals respectively corresponding to the plurality of models based on the obtained plurality of information.

11. A method for operating an artificial intelligence moving agent, the method comprising:
detecting a movement of an object;
providing an image of the object to an artificial intelligence model to obtain information on whether to transmit the image of the object when the movement of the object is detected; and
transmitting the image of the object to a terminal based on the obtained information.

12. The method for operating an artificial intelligence moving agent of claim 11, further comprising receiving feedback corresponding to the image of the object from the terminal and training the artificial intelligence model using the feedback, and
wherein the feedback is the information on whether to transmit the image of the object.

13. The method for operating an artificial intelligence moving agent of claim 12, wherein the training of the artificial intelligence model includes:
training the artificial intelligence model by labeling the feedback on the image of the object, using a supervised learning scheme.

14. The method for operating an artificial intelligence moving agent of claim 12, wherein the training of the artificial intelligence model includes:
assigning a reward or a penalty to the artificial intelligence model based on the feedback to train the artificial intelligence model using a reinforcement learning scheme.

15. The method for operating an artificial intelligence moving agent of claim 11, wherein the artificial intelligence model is a neural network pre-trained to extract a feature vector including at least one of a kind of the object, the movement of the object, or a detailed classification of the object.
